(19) United States
(12) Patent Application Publication
(10) Pub. No.: US 2024/0220367 A1
(43) Pub. Date: Jul. 4, 2024

(54) AUTOMATED BASIC INPUT/OUTPUT SYSTEM (BIOS) RECOVERY

(71) Applicant: Altiostar Networks India Private Limited, Raman Nagar, Bangalore (IN)

(72) Inventors: Prasad HIREMATH, Bangalore (IN); Amith BASAVARAJ, Bangalore (IN); Nirav SALOT, Bangalore (IN); Mahesh SIVAPURAM, Bangalore (IN); Arun MENON, Bangalore (IN); Ravi BHAT, Bangalore (IN); Lokesh CHIMBILI, Bangalore (IN)

(21) Appl. No.: 17/926,680

(22) PCT Filed: Nov. 16, 2022
(86) PCT No.: PCT/US22/79924

§ 371 Date: Nov. 21, 2022

(30) Foreign Application Priority Data
Sep. 28, 2022 (IN) 202241055636

(51) Int. Cl. G06F 11/14; G06F 9/4401

(52) U.S. Cl. CPC G06F 11/1441; G06F 9/4406; G06F 2201/805

(57) ABSTRACT

In general, the current subject matter relates to automated basic input/output system (BIOS) recovery. In some implementations, automated BIOS recovery can include attempting to boot an operating system (OS) from a BIOS while running an Intelligent Platform Management Interface (IPMI) watchdog timer. The BIOS can be stored in a first partition of a memory of a communication device in a wireless communication system. After a timeout of the watchdog timer, performance of a BIOS recovery procedure can be automatically triggered. After the performance of the BIOS recovery procedure, the OS can be automatically re-attempted to boot from the BIOS.

### CROSS-REFERENCE TO RELATED APPLICATIONS

The present application claims priority to Indian Patent Appl. No. 202241055636 filed Sep. 28, 2022, and entitled “Automated Basic Input/Output System (BIOS) Recovery,” and incorporates its disclosure herein by reference in its entirety.

### TECHNICAL FIELD

In some implementations, the current subject matter relates to telecommunications systems, and in particular, to automated basic input/output system (BIOS) recovery, such as for communication devices in wireless communication systems.

### BACKGROUND

In today's world, cellular networks provide on-demand communications capabilities to individuals and business entities. Typically, a cellular network is a wireless network that can be distributed over land areas, which are called cells. Each such cell is served by at least one fixed-location transceiver, which is referred to as a cell site or a base station. Each cell can use a different set of frequencies than its neighbor cells in order to avoid interference and provide improved service within each cell. When cells are joined together, they provide radio coverage over a wide geographic area, which enables a large number of mobile telephones, and/or other wireless devices or portable transceivers to communicate with each other and with fixed transceivers and telephones anywhere in the network. Such communications are performed through base stations and are accomplished even if the mobile transceivers are moving through more than one cell during transmission. Major wireless communications providers have deployed such cell sites throughout the world, thereby allowing communications mobile phones and mobile computing devices to be connected to the public switched telephone network and public Internet.

A mobile telephone is a portable telephone that is capable of receiving and/or making telephone and/or data calls through a cell site or a transmitting tower by using radio waves to transfer signals to and from the mobile telephone. In view of a large number of mobile telephone users, current mobile telephone networks provide a limited and shared resource. In that regard, cell sites and handsets can change frequency and use low power transmitters to allow simultaneous usage of the networks by many callers with less interference. Coverage by a cell site can depend on a particular geographical location and/or a number of users that can potentially use the network. For example, in a city, a cell site can have a range of up to approximately ½ mile; in rural areas, the range can be as much as 5 miles; and in some areas, a user can receive signals from a cell site 25 miles away.

The following are examples of some of the digital cellular technologies that are in use by the communications providers: Global System for Mobile Communications (“GSM”), General Packet Radio Service (“GPRS”), cdmaOne, CDMA2000, Evolution-Data Optimized (“EV-DO”), Enhanced Data Rates for GSM Evolution (“EDGE”), Universal Mobile Telecommunications System (“UMTS”), Digital Enhanced Cordless Telecommunications (“DECT”), Digital AMPS (“IS-136/TDMA”), and Integrated Digital Enhanced Network (“iDEN”). The Long Term Evolution, or 4G LTE, which was developed by the Third Generation Partnership Project (“3GPP”) standards body, is a standard for a wireless communication of high-speed data for mobile phones and data terminals. A 5G standard is currently being developed and deployed. 3GPP cellular technologies like LTE and 5G NR are evolutions of earlier generation 3GPP technologies like the GSM/EDGE and UMTS/HSPA digital cellular technologies and allows for increasing capacity and speed by using a different radio interface together with core network improvements.

Cellular networks can be divided into radio access networks and core networks. The radio access network (RAN) can include network functions that can handle radio layer communications processing. The core network can include network functions that can handle higher layer communications, e.g., internet protocol (IP), transport layer and applications layer. In some cases, the RAN functions can be split into baseband unit functions and the radio unit functions, where a radio unit connected to a baseband unit via a fronthaul network, for example, can be responsible for lower layer processing of a radio physical layer while a baseband unit can be responsible for the higher layer radio protocols, e.g., MAC, RLC, etc.

A computer system at a cell, such as a base station and/or components of a base station, runs an operating system (“OS”) to manage its operations including management of its hardware components and software resources. An OS may be installed on the computer system that is used initially when the hardware is deployed at the cell. The OS may, however, experience an error at some point during the computer system's operation that partially or fully impairs operation of the computer system. The computer system may thus be partially or fully non-operational, thereby impairing functionality of the cell site while the computer system experiences downtime. Further, traditionally, a maintenance worker physically visits the cell site to assess the errors and repair the OS, which may include a reinstallation of an OS on the computer system, such as if OS boot failure occurred. Waiting for a maintenance worker to reach the cell site and then address the OS error prolongs the downtime. Some computer systems may allow for remote OS repair or reinstallation, but such remote access of the computer system may not be secure and still requires manual intervention by a maintenance worker.

Additionally, an OS typically requires updating over time to address various issues such as newly located software bugs, provide improved security, and other issues. Traditionally, the computer system at the cell site must be taken offline while the OS updates, thereby impairing functionality of the cell site while the computer system experiences downtime.

### SUMMARY

In some implementations, the current subject matter relates to a computer-implemented method. The method can include attempting to boot an operating system (OS) from a Basic Input/Output System (BIOS) while running an Intelligent Platform Management Interface (IPMI) watchdog timer. The BIOS can be stored in a first partition of a memory of a communication device in a wireless communication system. The method can also include, after a timeout of the watchdog timer, automatically triggering performance of a BIOS recovery procedure, and, after the performance of the BIOS recovery procedure, automatically re-attempting to boot the OS from the BIOS.

In some implementations, the current subject matter can include one or more of the following optional features.

In some implementations, the method can further include, after the timeout of the watchdog timer and before triggering the performance of the BIOS recovery procedure, incrementing a failure counter, the method can further include determining if the failure counter is less than a threshold, and the performance of the BIOS recovery procedure can be triggered in response to determining that the failure counter is not less than the threshold. Further, the method can further include, in response to determining that the failure counter is less than the threshold, re-attempting to boot the OS from the BIOS without triggering the performance of the BIOS recovery procedure; the failure counter can be zero when the OS is attempted to be booted from the first BIOS, and the method can further include resetting the failure counter to zero in response to determining that the failure counter is not less than the threshold; and/or the failure counter can be zero when the OS is attempted to be booted from the first BIOS, and the method can further include, in response to the timeout of the watchdog timer, incrementing the failure counter by one.

In some implementations, attempting to boot the OS can includes a BIOS POST attempt, and the timeout of the watchdog timer can occur during the BIOS POST attempt.

In some implementations, attempting to boot the OS can include an attempt to load the OS, and the timeout of the watchdog timer can occur during the OS load attempt.

In some implementations, the timeout of the watchdog timer can include timeout of at least one of a BIOS FRB2 timeout, a BIOS FRB3 timeout, and a BIOS POST timeout.

In some implementations, performing the BIOS recovery procedure can include copying a golden BIOS image stored in a second partition of the memory of the communication device to the BIOS. Further, the golden BIOS image can be pre-stored in the second partition of the memory during manufacturing of the communication device.

In some implementations, the communication device can be a DU.

In some implementations, at least one of the attempting and the automatically attempting can be performed by a base station in the wireless communication system. Further, the base station can include at least one of an eNodeB base station, a gNodeB base station, a wireless base station, and any combination thereof.

In some implementations, the wireless communication system can be at least one of a long term evolution communications system, a new radio communications system, and any combination thereof.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1a illustrates an exemplary conventional long term evolution (“LTE”) communications system;

FIG. 1b illustrates further detail of the exemplary LTE system shown in FIG. 1a;

FIG. 1c illustrates additional detail of the evolved packet core of the exemplary LTE system shown in FIG. 1a;

FIG. 1d illustrates an exemplary evolved Node B of the exemplary LTE system shown in FIG. 1a;

FIG. 2 illustrates further detail of an evolved Node B shown in FIGS. 1a-d;

FIG. 3 illustrates an exemplary virtual radio access network, according to some implementations of the current subject matter;

FIG. 4 illustrates an exemplary 3GPP split architecture to provide its users with use of higher frequency bands;

FIG. 5a illustrates an exemplary 5G wireless communication system;

FIG. 5b illustrates an exemplary layer architecture of the split gNB and/or a split ng-eNB (e.g., next generation eNB that may be connected to 5GC);

FIG. 5c illustrates an exemplary functional split in the gNB architecture shown in FIGS. 5a-b;

FIG. 6 illustrates a dual BIOS FLASH configuration of a device, according to some implementations of the current subject matter;

FIG. 7 illustrates a method for performing automated BIOS recovery, according to some implementations of the current subject matter;

FIG. 8 illustrates another method for performing automated BIOS recovery, according to some implementations of the current subject matter;

FIG. 9 illustrates an exemplary system, according to some implementations of the current subject matter; and

FIG. 10 illustrates an exemplary method, according to some implementations of the current subject matter.

### DETAILED DESCRIPTION

The current subject matter can provide for systems and methods that can be implemented in wireless communications systems. Such systems can include various wireless communications systems, including 5G New Radio communications systems, long term evolution communication systems, etc.

In general, the current subject matter relates to automated BIOS recovery.

In some implementations of the current subject matter, a computer system can have multiple instances of an OS installed thereon. The OS instances, also referred to herein as OS partitions, are partitioned from one another in a memory of the computer system. Thus, an error with one of the OS instances may be isolated from and not affect any of the other OS instances. In the event that an instance of the OS being booted is unable to boot successfully, the other OS instances may provide redundancy with one of the other OS instances being automatically booted.

In some implementations of the current subject matter, an OS can be attempted to be booted from a first Basic Input/Output System (“BIOS”) pre-stored in a first partition of a memory of a computer system, e.g., a computer system of a communication device in a wireless communication system such as a long term evolution communications system, a new radio communications system, or other wireless communication system. The OS can run on the communication device in response to the OS booting successfully from the first BIOS. In response to the OS not booting successfully from the first BIOS, a BIOS recovery procedure can be automatically triggered. The BIOS recovery procedure can be implemented in accordance with a typical BIOS recovery procedure, as will be appreciated by those skilled in the art. In general, the BIOS recovery procedure can load a backup BIOS image which in turn successfully loads a compatible backup OS image available either on the same computer system or additional computer system(s).

One or more aspects of the current subject matter can be incorporated into transmitter and/or receiver components of base stations (e.g., gNodeBs, eNodeBs, etc.) in such communications systems. The following is a general discussion of long-term evolution communications systems and 5G New Radio communication systems.

### I. Long Term Evolution Communications System

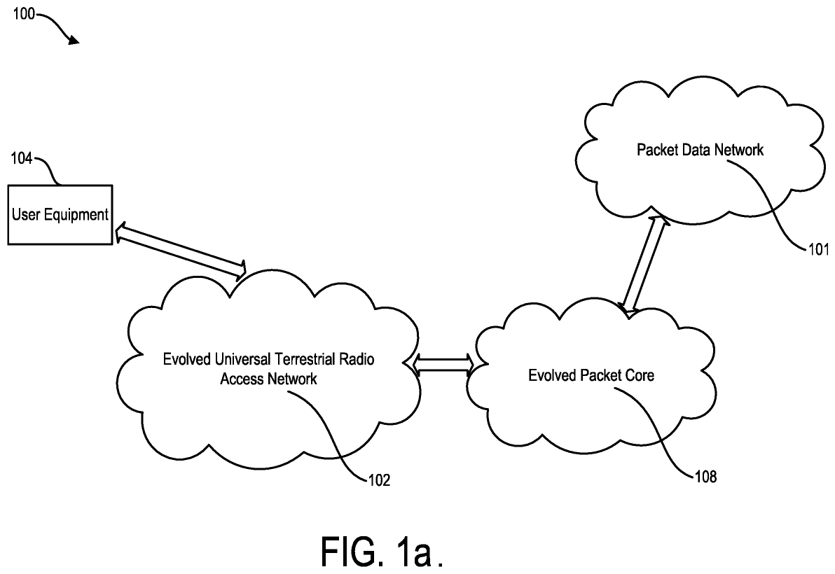

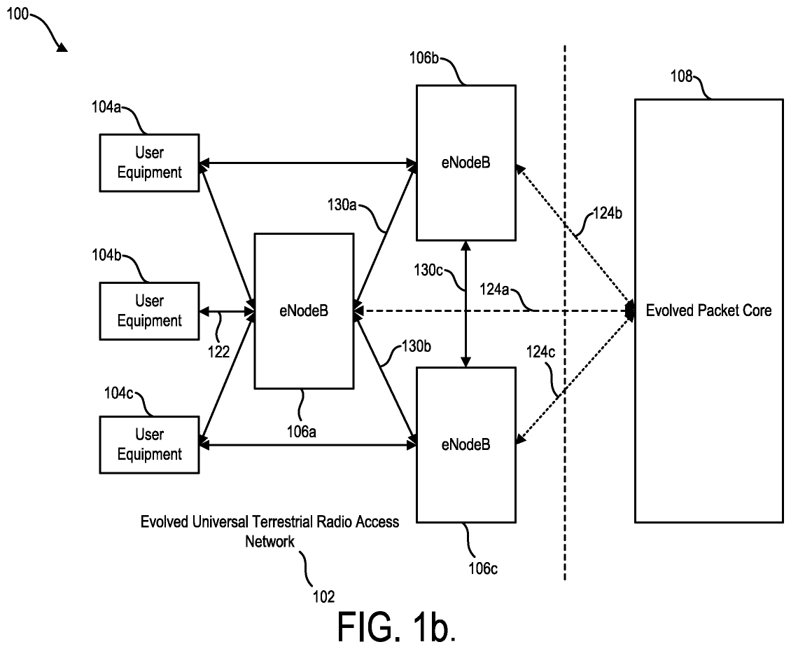

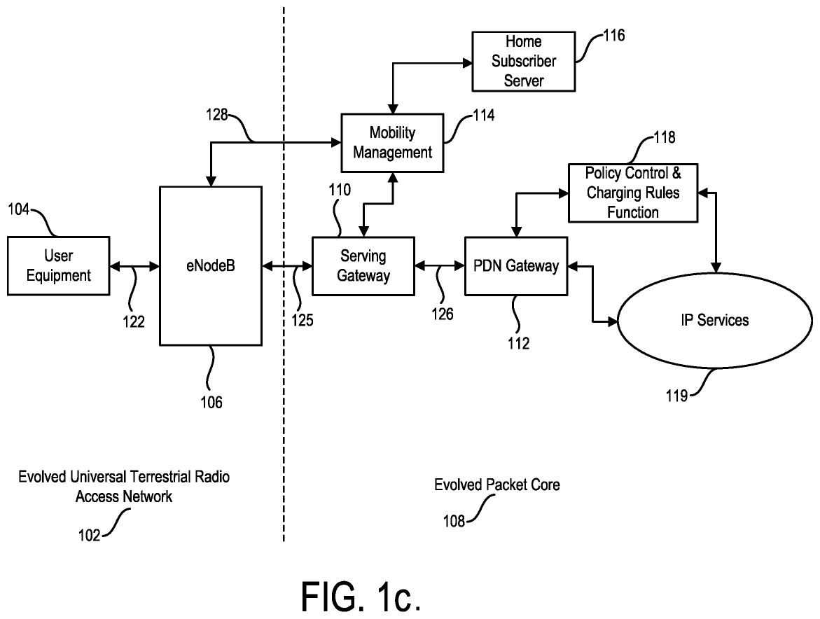

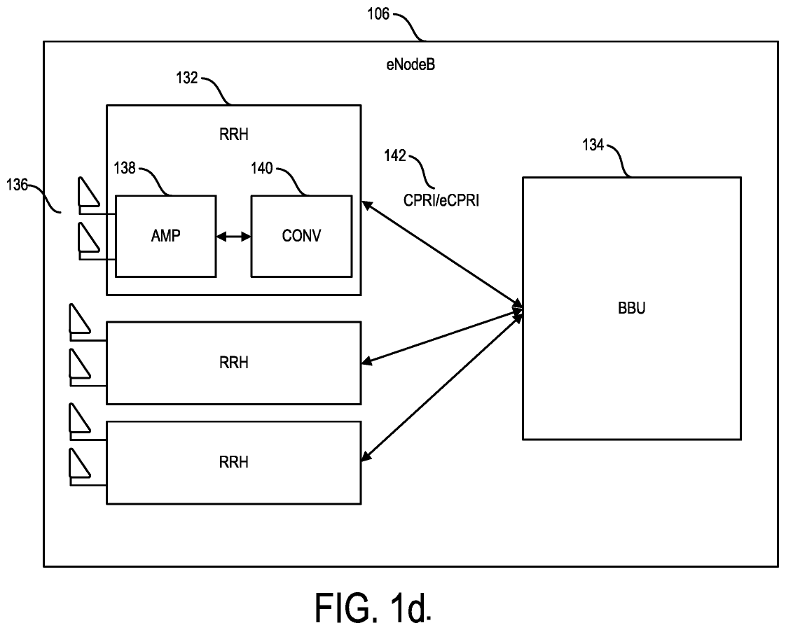

FIGS. 1a-c and 2 illustrate an exemplary conventional long-term evolution (“LTE”) communication system 100 along with its various components. An LTE system or a 4G LTE, as it is commercially known, is governed by a standard for wireless communication of high-speed data for mobile telephones and data terminals. The standard is an evolution of the GSM/EDGE (“Global System for Mobile Communications”/“Enhanced Data rates for GSM Evolution”) as well as UMTS/HSPA (“Universal Mobile Telecommunications System”/“High Speed Packet Access”) network technologies. The standard was developed by the 3GPP (“3rd Generation Partnership Project”).

As shown in FIG. 1a, the system 100 can include an evolved universal terrestrial radio access network (“EUTRAN”) 102, an evolved packet core (“EPC”) 108, and a packet data network (“PDN”) 101, where the EUTRAN 102 and EPC 108 provide communication between a user equipment 104 and the PDN 101. The EUTRAN 102 can include a plurality of evolved node B's (“eNodeB” or “ENODEB” or “enodeb” or “eNB”) or base stations 106 (a, b, c) (as shown in FIG. 1b) that provide communication capabilities to a plurality of user equipment 104(a, b, c). The user equipment 104 can be a mobile telephone, a smartphone, a tablet, a personal computer, a personal digital assistant (“PDA”), a server, a data terminal, and/or any other type of user equipment, and/or any combination thereof. The user equipment 104 can connect to the EPC 108 and eventually, the PDN 101, via any eNodeB 106. Typically, the user equipment 104 can connect to the nearest, in terms of distance, eNodeB 106. In the LTE system 100, the EUTRAN 102 and EPC 108 work together to provide connectivity, mobility and services for the user equipment 104.

FIG. 1b illustrates further detail of the network 100 shown in FIG. 1a. As stated above, the EUTRAN 102 includes a plurality of eNodeBs 106, also known as cell sites. The eNodeBs 106 provides radio functions and performs key control functions including scheduling of air link resources or radio resource management, active mode mobility or handover, and admission control for services. The eNodeBs 106 are responsible for selecting which mobility management entities (MMEs, as shown in FIG. 1c) will serve the user equipment 104 and for protocol features like header compression and encryption. The eNodeBs 106 that make up an EUTRAN 102 collaborate with one another for radio resource management and handover.

Communication between the user equipment 104 and the eNodeB 106 occurs via an air interface 122 (also known as “LTE-Uu” interface). As shown in FIG. 1b, the air interface 122 provides communication between user equipment 104b and the eNodeB 106a. The air interface 122 uses Orthogonal Frequency Division Multiple Access (“OFDMA”) and Single Carrier Frequency Division Multiple Access (“SC-FDMA”), an OFDMA variant, on the downlink and uplink respectively. OFDMA allows use of multiple known antenna techniques, such as, Multiple Input Multiple Output (“MIMO”).

The air interface 122 uses various protocols, which include a radio resource control (“RRC”) for signaling between the user equipment 104 and eNodeB 106 and non-access stratum (“NAS”) for signaling between the user equipment 104 and MME (as shown in FIG. 1c). In addition to signaling, user traffic is transferred between the user equipment 104 and eNodeB 106. Both signaling and traffic in the system 100 are carried by physical layer (“PHY”) channels.

Multiple eNodeBs 106 can be interconnected with one another using an X2 interface 130(a, b, c). As shown in FIG. 1b, X2 interface 130a provides interconnection between eNodeB 106a and eNodeB 106b; X2 interface 130b provides interconnection between eNodeB 106a and eNodeB 106c; and X2 interface 130c provides interconnection between eNodeB 106b and eNodeB 106c. The X2 interface can be established between two eNodeBs in order to provide an exchange of signals, which can include a load- or interference-related information as well as handover-related information. The eNodeBs 106 communicate with the evolved packet core 108 via an S1 interface 124(a, b, c). The S1 interface 124 can be split into two interfaces: one for the control plane (shown as control plane interface (S1-MME interface) 128 in FIG. 1c) and the other for the user plane (shown as user plane interface (S1-U interface) 125 in FIG. 1c).

The EPC 108 establishes and enforces Quality of Service (“QoS”) for user services and allows user equipment 104 to maintain a consistent internet protocol (“IP”) address while moving. It should be noted that each node in the network 100 has its own IP address. The EPC 108 is designed to interwork with legacy wireless networks. The EPC 108 is also designed to separate control plane (i.e., signaling) and user plane (i.e., traffic) in the core network architecture, which allows more flexibility in implementation, and independent scalability of the control and user data functions.

The EPC 108 architecture is dedicated to packet data and is shown in more detail in FIG. 1c. The EPC 108 includes a serving gateway (S-GW) 110, a PDN gateway (P-GW) 112, a mobility management entity (“MME”) 114, a home subscriber server (“HSS”) 116 (a subscriber database for the EPC 108), and a policy control and charging rules function (“PCRF”) 118. Some of these (such as S-GW, P-GW, MME, and HSS) are often combined into nodes according to the manufacturer's implementation.

The S-GW 110 functions as an IP packet data router and is the user equipment's bearer path anchor in the EPC 108. Thus, as the user equipment moves from one eNodeB 106 to another during mobility operations, the S-GW 110 remains the same and the bearer path towards the EUTRAN 102 is switched to talk to the new eNodeB 106 serving the user equipment 104. If the user equipment 104 moves to the domain of another S-GW 110, the MME 114 will transfer all of the user equipment's bearer paths to the new S-GW. The S-GW 110 establishes bearer paths for the user equipment to one or more P-GWs 112. If downstream data are received for an idle user equipment, the S-GW 110 buffers the downstream packets and requests the MME 114 to locate and reestablish the bearer paths to and through the EUTRAN 102.

The P-GW 112 is the gateway between the EPC 108 (and the user equipment 104 and the EUTRAN 102) and PDN 101 (shown in FIG. 1a). The P-GW 112 functions as a router for user traffic as well as performs functions on behalf of the user equipment. These include IP address allocation for the user equipment, packet filtering of downstream user traffic to ensure it is placed on the appropriate bearer path, enforcement of downstream QoS, including data rate. Depending upon the services a subscriber is using, there may be multiple user data bearer paths between the user equipment 104 and P-GW 112. The subscriber can use services on PDNs served by different P-GWs, in which case the user equipment has at least one bearer path established to each P-GW 112. During handover of the user equipment from one eNodeB to another, if the S-GW 110 is also changing, the bearer path from the P-GW 112 is switched to the new S-GW.

The MME 114 manages user equipment 104 within the EPC 108, including managing subscriber authentication, maintaining a context for authenticated user equipment 104, establishing data bearer paths in the network for user traffic, and keeping track of the location of idle mobiles that have not detached from the network. For idle user equipment 104 that needs to be reconnected to the access network to receive downstream data, the MME 114 initiates paging to locate the user equipment and re-establishes the bearer paths to and through the EUTRAN 102. MME 114 for a particular user equipment 104 is selected by the eNodeB 106 from which the user equipment 104 initiates system access. The MME is typically part of a collection of MMEs in the EPC 108 for the purposes of load sharing and redundancy. In the establishment of the user's data bearer paths, the MME 114 is responsible for selecting the P-GW 112 and the S-GW 110, which will make up the ends of the data path through the EPC 108.

The PCRF 118 is responsible for policy control decision-making, as well as for controlling the flow-based charging functionalities in the policy control enforcement function (“PCEF”), which resides in the P-GW 110. The PCRF 118 provides the QoS authorization (QOS class identifier (“QCI”) and bit rates) that decides how a certain data flow will be treated in the PCEF and ensures that this is in accordance with the user's subscription profile.

As stated above, the IP services 119 are provided by the PDN 101 (as shown in FIG. 1a).

FIG. 1d illustrates an exemplary structure of eNodeB 106. The eNodeB 106 can include at least one remote radio head (“RRH”) 132 (typically, there can be three RRH 132) and a baseband unit (“BBU”) 134. The RRH 132 can be connected to antennas 136. The RRH 132 and the BBU 134 can be connected using an optical interface that is compliant with common public radio interface (“CPRI”)/enhanced CPRI (“eCPRI”) 142 standard specification either using RRH specific custom control and user plane framing methods or using O-RAN Alliance compliant Control and User plane framing methods. The operation of the eNodeB 106 can be characterized using the following standard parameters (and specifications): radio frequency band (Band4, Band9, Band17, etc.), bandwidth (5, 10, 15, 20 MHz), access scheme (downlink: OFDMA; uplink: SC-OFDMA), antenna technology (Single user and multi user MIMO; Uplink: Single user and multi user MIMO), number of sectors (6 maximum), maximum transmission rate (downlink: 150 Mb/s; uplink: 50 Mb/s), S1/X2 interface (1000Base-SX, 1000Base-T), and mobile environment (up to 350 km/h). The BBU 134 can be responsible for digital baseband signal processing, termination of S1 line, termination of X2 line, call processing and monitoring control processing. IP packets that are received from the EPC 108 (not shown in FIG. 1d) can be modulated into digital baseband signals and transmitted to the RRH 132. Conversely, the digital baseband signals received from the RRH 132 can be demodulated into IP packets for transmission to EPC 108.

The RRH 132 can transmit and receive wireless signals using antennas 136. The RRH 132 can convert (using converter (“CONV”) 140) digital baseband signals from the BBU 134 into radio frequency (“RF”) signals and power amplify (using amplifier (“AMP”) 138) them for transmission to user equipment 104 (not shown in FIG. 1d). Conversely, the RF signals that are received from user equipment 104 are amplified (using AMP 138) and converted (using CONV 140) to digital baseband signals for transmission to the BBU 134.

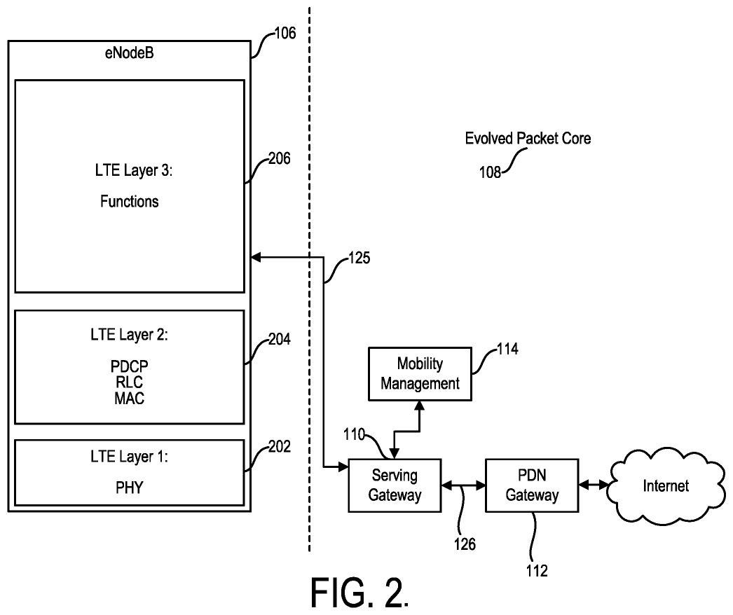

FIG. 2 illustrates an additional detail of an exemplary eNodeB 106. The eNodeB 106 includes a plurality of layers: LTE layer 1 202, LTE layer 2 204, and LTE layer 3 206. The LTE layer 1 includes a physical layer (“PHY”). The LTE layer 2 includes a medium access control (“MAC”), a radio link control (“RLC”), a packet data convergence protocol (“PDCP”). The LTE layer 3 includes various functions and protocols, including a radio resource control (“RRC”), a dynamic resource allocation, eNodeB measurement configuration and provision, a radio admission control, a connection mobility control, and radio resource management (“RRM”). The RLC protocol is an automatic repeat request (“ARQ”) fragmentation protocol used over a cellular air interface. The RRC protocol handles control plane signaling of LTE layer 3 between the user equipment and the EUTRAN. RRC includes functions for connection establishment and release, broadcast of system information, radio bearer establishment/reconfiguration and release, RRC connection mobility procedures, paging notification and release, and outer loop power control. The PDCP performs IP header compression and decompression, transfer of user data and maintenance of sequence numbers for Radio Bearers. The BBU 134, shown in FIG. 1d, can include LTE layers L1-L3.

One of the primary functions of the eNodeB 106 is radio resource management, which includes scheduling of both uplink and downlink air interface resources for user equipment 104, control of bearer resources, and admission control. The eNodeB 106, as an agent for the EPC 108, is responsible for the transfer of paging messages that are used to locate mobiles when they are idle. The eNodeB 106 also communicates common control channel information over the air, header compression, encryption and decryption of the user data sent over the air, and establishing handover reporting and triggering criteria. As stated above, the eNodeB 106 can collaborate with other eNodeB 106 over the X2 interface for the purposes of handover and interference management. The eNodeBs 106 communicate with the EPC's MME via the S1-MME interface and to the S-GW with the S1-U interface. Further, the eNodeB 106 exchanges user data with the S-GW over the S1-U interface. The eNodeB 106 and the EPC 108 have a many-to-many relationship to support load sharing and redundancy among MMEs and S-GWs. The eNodeB 106 selects an MME from a group of MMEs so the load can be shared by multiple MMEs to avoid congestion.

### II. 5G NR Wireless Communications Networks

In some implementations, the current subject matter relates to a 5G new radio (“NR”) communications system. The 5G NR is a next telecommunications standard beyond the 4G/IMT-Advanced standards. 5G networks offer at higher capacity than current 4G, allow higher number of mobile broadband users per area unit, and allow consumption of higher and/or unlimited data quantities in gigabyte per month and user. This can allow users to stream high-definition media many hours per day using mobile devices, even when it is not possible to do so with Wi-Fi networks. 5G networks have an improved support of device-to-device communication, lower cost, lower latency than 4G equipment and lower battery consumption, etc. Such networks have data rates of tens of megabits per second for a large number of users, data rates of 100 Mb/s for metropolitan areas, 1 Gb/s simultaneously to users within a confined area (e.g., office floor), a large number of simultaneous connections for wireless sensor networks, an enhanced spectral efficiency, improved coverage, enhanced signaling efficiency, 1-10 ms latency, reduced latency compared to existing systems.

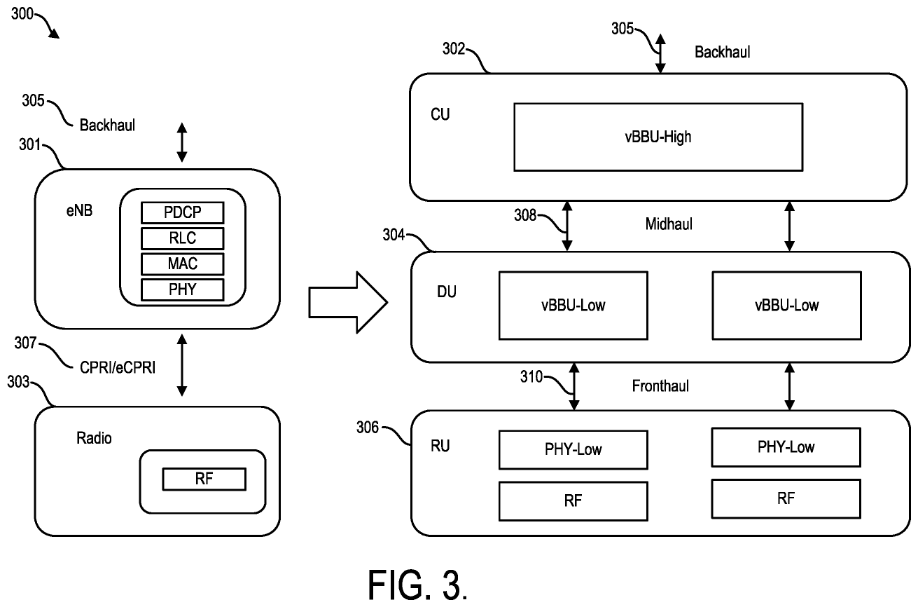

FIG. 3 illustrates an exemplary virtual radio access network 300. The network 300 can provide communications between various components, including a base station (e.g., eNodeB, gNodeB) 301, a radio equipment 303, a centralized unit 302, a digital unit 304, and a radio device 306. The components in the system 300 can be communicatively coupled to a core using a backhaul link 305. A centralized unit (“CU”) 302 can be communicatively coupled to a distributed unit (“DU”) 304 using a midhaul connection 308. The radio frequency (“RU”) components 306 can be communicatively coupled to the DU 304 using a fronthaul connection 310.

In some implementations, the CU 302 can provide intelligent communication capabilities to one or more DU units 304. The units 302, 304 can include one or more base stations, macro base stations, micro base stations, remote radio heads, etc. and/or any combination thereof.

In lower layer split architecture environment, a CPRI bandwidth requirement for NR can be 100s of Gb/s. CPRI compression can be implemented in the DU and RU (as shown in FIG. 3). In 5G communications systems, compressed CPRI over Ethernet frame is referred to as eCPRI and is the recommended fronthaul network. The architecture can allow for standardization of fronthaul/midhaul, which can include a higher layer split (e.g., Option 2 or Option 3-1 (Upper/Lower RLC split architecture)) and fronthaul with L1-split architecture (Option 7).

In some implementations, the lower layer-split architecture (e.g., Option 7) can include a receiver in the uplink, joint processing across multiple transmission points (TPs) for both DL/UL, and transport bandwidth and latency requirements for ease of deployment. Further, the current subject matter's lower layer-split architecture can include a split between cell-level and user-level processing, which can include cell-level processing in remote unit (“RU”) and user-level processing in DU. Further, using the current subject matter's lower layer-split architecture, frequency-domain samples can be transported via Ethernet fronthaul, where the frequency-domain samples can be compressed for reduced fronthaul bandwidth.

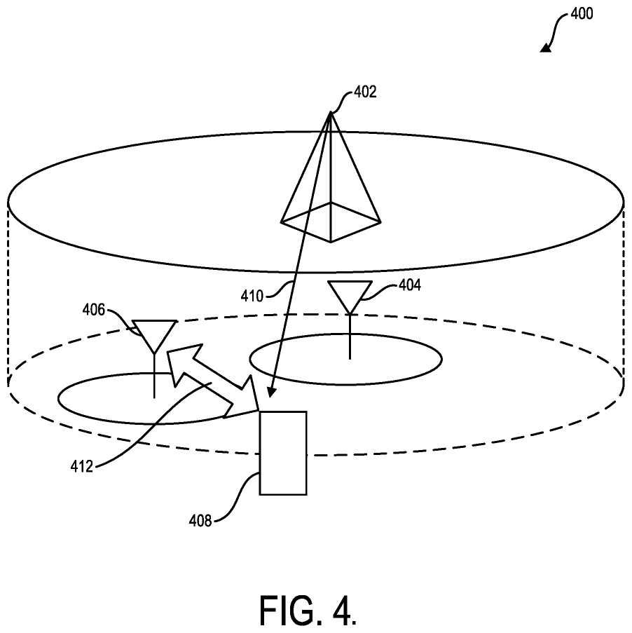

FIG. 4 illustrates an exemplary communications system 400 that can implement a 5G technology and can provide its users with use of higher frequency bands (e.g., greater than 10 GHz). The system 400 can include a macro cell 402 and small cells 404, 406.

A mobile device 408 can be configured to communicate with one or more of the small cells 404, 406. The system 400 can allow splitting of control planes (C-plane) and user planes (U-plane) between the macro cell 402 and small cells 404, 406, where the C-plane and U-plane are utilizing different frequency bands. In particular, the small cells 404, 406 can be configured to utilize higher frequency bands when communicating with the mobile device 408. The macro cell 402 can utilize existing cellular bands for C-plane communications. The mobile device 408 can be communicatively coupled via U-plane 412, where the small cell (e.g., small cell 406) can provide higher data rate and more flexible/cost/energy efficient operations. The macro cell 402, via C-plane 410, can maintain good connectivity and mobility. Further, in some cases, LTE and NR can be transmitted on the same frequency.

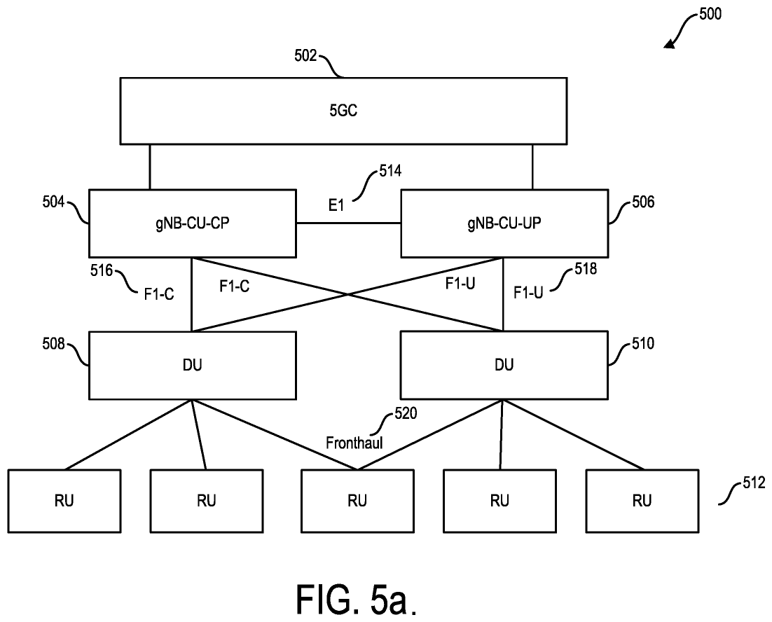

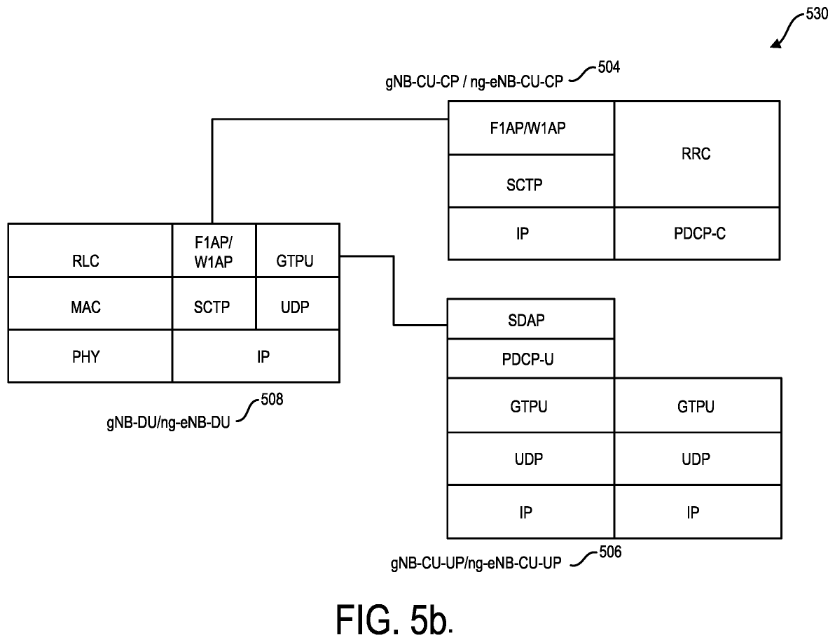

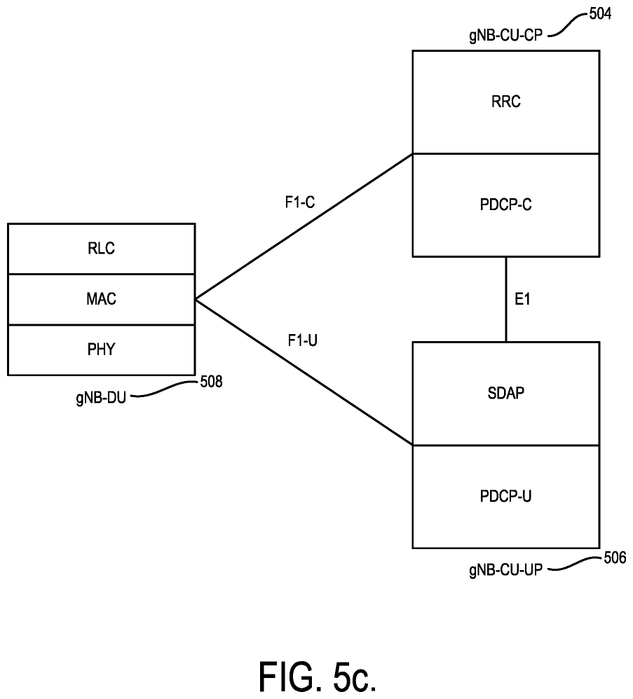

FIG. 5a illustrates an exemplary 5G wireless communication system 500, according to some implementations of the current subject matter. The system 500 can be configured to have a lower layer split architecture in accordance with Option 7-2. The system 500 can include a core network 502 (e.g., 5G Core) and one or more gNodeBs (or gNBs), where the gNBs can have a centralized unit gNB-CU. The gNB-CU can be logically split into control plane portion, gNB-CU-CP, 504 and one or more user plane portions, gNB-CU-UP, 506. The control plane portion 504 and the user plane portion 506 can be configured to be communicatively coupled using an E1 communication interface 514 (as specified in the 3GPP Standard). The control plane portion 504 can be configured to be responsible for execution of the RRC and PDCP protocols of the radio stack.

The control plane and user plane portions 504, 506 of the centralized unit of the gNB can be configured to be communicatively coupled to one or more distributed units (DU) 508, 510, in accordance with the higher layer split architecture. The distributed units 508, 510 can be configured to execute RLC, MAC and upper part of PHY layers protocols of the radio stack. The control plane portion 504 can be configured to be communicatively coupled to the distributed units 508, 510 using F1-C communication interfaces 516, and the user plane portions 506 can be configured to be communicatively coupled to the distributed units 508, 510 using F1-U communication interfaces 518. The distributed units 508, 510 can be coupled to one or more remote radio units (RU) 512 via a fronthaul network 520 (which may include one or switches, links, etc.), which in turn communicate with one or more user equipment (not shown in FIG. 5a). The remote radio units 512 can be configured to execute a lower part of the PHY layer protocols as well as provide antenna capabilities to the remote units for communication with user equipments (similar to the discussion above in connection with FIGS. 1a-2).

FIG. 5b illustrates an exemplary layer architecture 530 of the split gNB. The architecture 530 can be implemented in the communications system 500 shown in FIG. 5a, which can be configured as a virtualized disaggregated radio access network (RAN) architecture, whereby layers L1, L2, L3 and radio processing can be virtualized and disaggregated in the centralized unit(s), distributed unit(s) and radio unit(s). As shown in FIG. 5b, the gNB-DU 508 can be communicatively coupled to the gNB-CU-CP control plane portion 504 (also shown in FIG. 5a) and gNB-CU-UP user plane portion 506. Each of components 504, 506, 508 can be configured to include one or more layers.

The gNB-DU 508 can include RLC, MAC, and PHY layers as well as various communications sublayers. These can include an F1 application protocol (F1-AP) sublayer, a GPRS tunneling protocol (GTPU) sublayer, a stream control transmission protocol (SCTP) sublayer, a user datagram protocol (UDP) sublayer and an internet protocol (IP) sublayer. As stated above, the distributed unit 508 may be communicatively coupled to the control plane portion 504 of the centralized unit, which may also include F1-AP, SCTP, and IP sublayers as well as radio resource control, and PDCP-control (PDCP-C) sublayers. Moreover, the distributed unit 508 may also be communicatively coupled to the user plane portion 506 of the centralized unit of the gNB. The user plane portion 506 may include service data adaptation protocol (SDAP), PDCP-user (PDCP-U), GTPU, UDP and IP sublayers.

FIG. 5c illustrates an exemplary functional split in the gNB architecture shown in FIGS. 5a-b. As shown in FIG. 5c, the gNB-DU 508 may be communicatively coupled to the gNB-CU-CP 504 and GNB-CU-UP 506 using an F1-C communication interface. The gNB-CU-CP 504 and GNB-CU-UP 506 may be communicatively coupled using an E1 communication interface. The higher part of the PHY layer (or Layer 1) may be executed by the gNB-DU 508, whereas the lower parts of the PHY layer may be executed by the RUs (not shown in FIG. 5c). As shown in FIG. 5c, the RRC and PDCP-C portions may be executed by the control plane portion 504, and the SDAP and PDCP-U portions may be executed by the user plane portion 506.

Some of the functions of the PHY layer in 5G communications network can include error detection on the transport channel and indication to higher layers, FEC encoding/decoding of the transport channel, hybrid ARQ soft-combining, rate matching of the coded transport channel to physical channels, mapping of the coded transport channel onto physical channels, power weighting of physical channels, modulation and demodulation of physical channels, frequency and time synchronization, radio characteristics measurements and indication to higher layers, MIMO antenna processing, digital and analog beamforming, RF processing, as well as other functions.

The MAC sublayer of Layer 2 can perform beam management, random access procedure, mapping between logical channels and transport channels, concatenation of multiple MAC service data units (SDUs) belonging to one logical channel into transport block (TB), multiplexing/demultiplexing of SDUs belonging to logical channels into/from TBs delivered to/from the physical layer on transport channels, scheduling information reporting, error correction through HARQ, priority handling between logical channels of one UE, priority handling between UEs by means of dynamic scheduling, transport format selection, and other functions. The RLC sublayer's functions can include transfer of upper layer packet data units (PDUs), error correction through ARQ, reordering of data PDUs, duplicate and protocol error detection, re-establishment, etc. The PDCP sublayer can be responsible for transfer of user data, various functions during re-establishment procedures, retransmission of SDUs, SDU discard in the uplink, transfer of control plane data, and others.

Layer 3's RRC sublayer can perform broadcasting of system information to NAS and AS, establishment, maintenance and release of RRC connection, security, establishment, configuration, maintenance and release of point-point radio bearers, mobility functions, reporting, and other functions.

### III. Automated BIOS Recovery

In some implementations of the current subject matter, a computer system (e.g., a computer system at a base station (e.g., gNodeB or gNB, eNodeB or eNB, ng-eNodeB or ng-eNB), such as those shown in and discussed above with regard to FIGS. 1a-5c, a commercial-off-the-shelf (COTS) server, etc.) can have multiple instances of an OS installed thereon. One of the OS instances may boot and run at a time. In the event that the instance of the OS being booted is unable to boot successfully, another OS instance may provide redundancy with one of the other OS instances being able to be automatically loaded as a backup that can then be booted. The computer system may thus be booted and have OS functionality despite the computer system experiencing an error, e.g., corrupt BIOS, corrupt BIOS image, secure boot signature verification failure of the boot loader due to mismatch of Unified Extensible Firmware Interface (UEFI) secure boot keys programmed as default in a BIOS image (as resulting from, e.g., BIOS upgrade or OS upgrade), or other error. Further, the OS may be booted without requiring manual intervention, locally or remotely, to address the error. Human error may therefore also be avoided. Resiliency of the device may be provided through the automated detection and recovery from a failure, especially when the deployments are distributed and remote such as in the case of communication devices in a wireless communication network.

The OS instances, also referred to herein as OS partitions, are partitioned from one another in a memory of the computer system. Thus, an error with one of the OS instances, e.g., an error in installation, an error that occurs during the boot process, an error that occurs during running of the OS, an error that occurs during upgrading or as a result of upgrading an OS, etc., may be isolated from and not affect any of the other OS instances. Only one of the OS instances is configured to be booted and run at a time such that each of the OS instances is configured to provide complete OS functionality to the computer system. The OS instances may thus provide redundancy to reduce or avoid computer system downtime since, due to the automatically triggered BIOS recovery procedure, the computer system may be functional. Reducing or avoiding downtime may reduce the loss of revenue and degradation of key performance indicators (“KPIs”) (accessibility) for the computer system's operator. When the computer system is a device in a wireless communications network, avoiding downtime may allow a cell site at which the computer system is located to remain fully functional and properly handle cell traffic as needed.

In some implementations of the current subject matter, an OS can be attempted to be booted from a first Basic Input/Output System (“BIOS”) pre-stored in a first partition of a memory of a computer system, e.g., a computer system of a communication device in a wireless communication system such as a long term evolution communications system, a new radio communications system, or other wireless communication system. The OS can run on the communication device in response to the OS booting successfully from the first BIOS. In response to the OS not booting successfully from the first BIOS, a BIOS recovery procedure can be automatically triggered. The BIOS recovery procedure can load a backup BIOS image which in turn successfully loads a compatible backup OS image available either on the same computer system or additional computer system(s).

The BIOS recovery procedure can be triggered using a Baseboard Management Controller (BMC) Intelligent Platform Management Interface (IPMI) watchdog timer. The BMC IPMI watchdog timer is described in the IPMI Specification Second Generation 2.0, Document Revision 1.1, Oct. 1, 2013 (“IPMI Specification”). As described in the IPMI Specification (page 22, section 1.7.27), “IPMI provides a standardized interface for a system Watchdog Timer. This timer can be used for BIOS, OS, and OEM applications. The timer can be configured to automatically generate selected actions when it expires.” Accordingly, in some implementations of the current subject matter, an action automatically generated when the watchdog timer expires can include BIOS recovery.

As also described in the IPMI Specification (page 379, section 27), “[t]he BMC implements a standardized ‘Watchdog Timer’ that can be used for a number of system timeout functions by system management software or by the BIOS. Setting a timeout value of ‘0’ allows the selected timeout action to occur immediately. This provides a standardized means for devices on the IPMB, such as Remote Management Cards, to perform emergency actions.” The IPMI Specification (page 379, section 27.2) states that “[t]he watchdog timer provides a ‘timer use’ field that indicates the current use assigned to the watchdog timer. The watchdog timer provides a corresponding set of ‘timer use expiration’ flags that are used to track the type of timeout(s) that has occurred.” Further, as provided in the IPMI Specification (pages 379-380, section 27.2), “[t]he Timer Use fields indicate:

| | |
|---|---|
| BIOS FRB2 | An FRB-2 (fault-resilient booting, level 2) timeout |
| timeout | has occurred. This indicates that the last system |
| | reset or power cycle was due to the system timeout |
| | during POST, presumed to be caused by a failure or |
| | hang related to the bootstrap processor⁶. |
| BIOS POST | In this mode, the timeout occurred while the |
| timeout | watchdog timer was being used by the BIOS for |
| | some purpose other than FRB-2 or OS Load |
| | Watchdog. |
| OS Load | The last reset or power cycle was caused by the timer |
| timeout | being used to ‘watchdog’ the interval from ‘boot’ to |
| | OS up and running. This mode requires system |
| | management software, or OS support. BIOS should |
| | clear this flag if it starts this timer during POST. |
| SMS | This indicates that the timer was being used by |
| ‘OS Watchdog’ | System Management Software. During run-time, |
| timeout | System Management Software (SMS) starts the |
| | timer, then periodically resets it to keep it from |
| | expiring. This periodic action serves as a ‘heartbeat’ |
| | that indicates that the OS (or at least the SMS task) |
| | is still functioning. If SMS hangs, the timer expires |
| | and the BMC generates a system reset. When SMS |
| | enables the timer, it should make sure the ‘SMS’ bit |
| | is set to indicate that the timer is being used in its |
| | ‘OS Watchdog’ role. |
| OEM | Indicates that the timer was being used for an OEM- |
| | specific function.” |

Footnote 6 states: “In a multiprocessor system, the bootstrap processor is defined as the processor that, on system power-up or hard reset, is allowed to run and execute the system initialization (BIOS POST) while the remaining processors are held in a idle state awaiting startup by the multiprocessing OS.”

As also described in the IPMI Specification (page 380, section 27.4.1), “[a]n application that wishes to use a particular pre-timeout interrupt can check for its support for issuing a Set Watching Timer command with the desired pre-timeout interrupt selection.” As further described in the IPMI Specification (page 381, section 27.6), “[t]he Set Watchdog Timer command is used for initializing and configuring the watchdog timer. The command is also used for stopping the timer. If the timer is already running, the Set Watchdog Timer command stops the timer (unless the ‘don't stop’ bit is set) and clears the Watchdog pre-timeout interrupt flag (see Get Message Flags command). BMC hard resets, system hard resets, and the Cold Reset command also stop the timer and clear the flag. Byte 1 is used for selecting the timer use and configuring whether an event will be logged on expiration. Byte 2 is used for selecting the timeout action and pre-timeout interrupt type. Byte 3 sets the pre-timeout interval. If the interval is set to zero, the pre-timeout action occurs concurrently with the timeout action. Byte 4 is used for clearing the Timer Use Expiration flags. A bit set in byte 4 of this command clears the corresponding bit in byte 5 of the Get Watchdog Timer command. Bytes 5 and 6 hold the least significant and most significant bytes, respectively, of the countdown value. The Watchdog timer decrement is one count/100 ms. The counter expires when the count reaches zero. If the counter is loaded with zero and the Reset Watchdog command is issued to start the timer, the associated timer events occur immediately.” The IPMI Specification at page 382, section 27.6 provides further information regarding bytes 1-6 of the Set Watchdog Timer Command. The IPMI Specification at page 383, section 27.7 provides further information regarding the Get Watchdog Timer Command.

The IPMI Specification also discusses Fault Resilient Booting (FRB). As stated in the IPMI Specification (page 6, section 1.3), the term “Fault Resilient Booting” is “used to describe system features and algorithms that improve the likelihood of the detection of, and recovery from, processor failures in a multiprocessor system.” A BMC can implement FRB level 1, level 2, and level 3. If a bootstrap processor (BSP) fails to successfully complete a boot process, the FRB implemented by the BMC can attempt to boot using another BSP. In general, FRB level 1 (FRB-1 or FRB1) can allow recovery from a Built-in Self Test (BIST) failure detected during Power On Self Test (POST), FRB level 2 (FRB-2 or FRB2) can allow recovery from a watchdog timer timeout during POST, and FRB level 3 (FRB-3 or FRB3) can allow recovery from a watchdog timer timeout on a hard reset or power-up.

As mentioned above, the watchdog timer includes a BIOS FRB2 timeout timer use field that indicates that an FRB-2 timeout has occurred, which indicates that the last system reset or power cycle was due to the system timeout during POST, presumed to be caused by a failure or hang related to the BSP.

The BMC can also include an FRB-3 timer that can start counting whenever the system comes out of a hard reset. (See IPMI Specification, page 505, section 42.2 and page 556, section 44.1.) If the BSP successfully resets and starts executing, the BIOS will disable the FRB-3 timer in the BMC.

In some implementations of the current subject matter, the BMC that includes the watchdog timer, e.g., stored in a memory thereof, can include a base station (e.g., gNodeB or gNB, eNodeB or eNB, ng-eNodeB or ng-eNB), such as those shown in and discussed above with regard to FIGS. 1a-5c), and in particular can include a DU of the base station (e.g., a DU such as the DU 304 of FIG. 3, the DU 508 or 510 of FIGS. 5a-5c, etc.). The BIOS recovery may thus occur for a communication device, e.g., a base station or a DU thereof, in a wireless communication system.

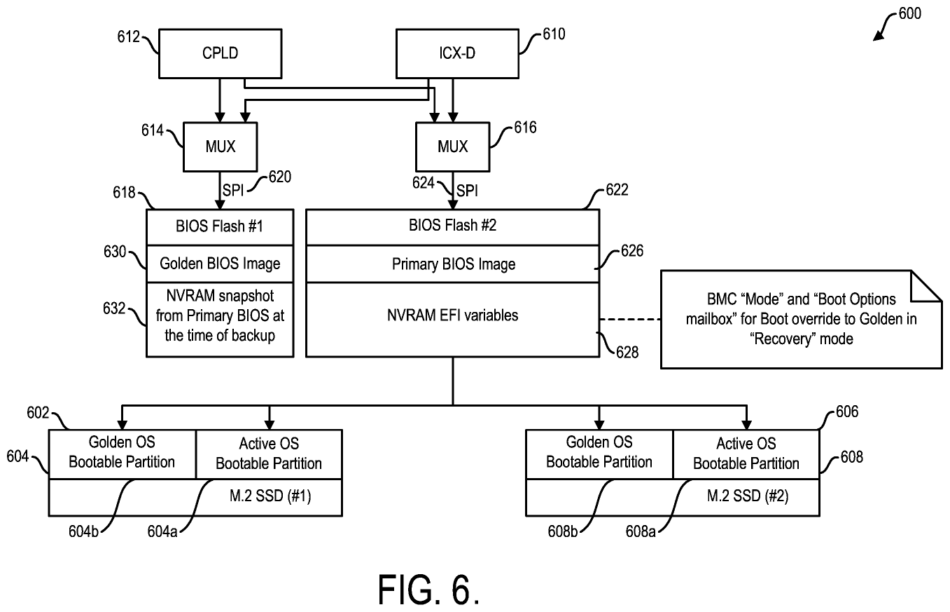

FIG. 6 illustrates one implementation of a computer system 600 according to some implementations of the current subject matter. The computer system 600 can be for a communication device (e.g., a base station (e.g., gNodeB or gNB, eNodeB or eNB, ng-eNodeB or ng-eNB), such as those shown in and discussed above with regard to FIGS. 1a-5c, or a DU of a base station (e.g., a DU such as the DU 304 of FIG. 3, the DU 508 or 510 of FIGS. 5a-5c, etc.)) configured to be used in a wireless communication network, a COTS server, or other device. The computer system 600 can be implemented as a BMC and thus include features of a BMC as discussed herein and as described in the IPMI specification.

The computer system 600 includes a first memory 602 that includes a plurality of OS partitions 604 (a first partition 604a and a second partition 604b) and a second memory 606 that includes a plurality of OS partitions 608 (a first partition 608a and a second partition 608b). The first partitions 604a, 608a are each shown in FIG. 6 as the active partition that is the current OS or that is running. The second partitions 604b, 608b are each shown in FIG. 6 as a golden partition installed during manufacturing. The golden partition cannot be upgraded, which may help ensure that the computer system 600 always has a bootable OS available. The golden partition can be used in a BIOS recovery procedure, as discussed further herein.

The first and second memories 602, 606 may each include one or more types of memories or storage devices. Each of the first and second memories 602, 606 is a solid state drive (“SSD”) in the illustrated implementation of FIG. 6 but can be or includes at least one other type, such as nonvolatile memory express (“NVMe”), a disk device, or other type.

Each of the first and second memories 602, 606 may be associated with a particular component of the computer system 600. In other implementations, the computer system 600 may include only one memory. In still other implementations, the computer system 600 may include one or more additional memories each associated with a corresponding one or more additional components of the computer system 600. For example, in some implementations of the current subject matter, the computer system 600 can be associated with a base station, the first memory 602 can be associated with a first DU (e.g., a DU such as the DU 304 of FIG. 3, the DU 508 or 510 of FIGS. 5a-5c, etc.) of the base station, and the second memory 604 can be associated with a second DU (e.g., a DU such as the DU 304 of FIG. 3, the DU 508 or 510 of FIGS. 5a-5c, etc.) of the base station. Any additional DUs of the base station may each be associated with an additional memory that is configured and used similar to the memories 602, 606 discussed herein.

The computer system 600 may also include, as shown in the implementation of FIG. 6, a processor 610, a complex programmable logic device (“CPLD”) 612, a first multiplexor (“MUX”) 614 communicatively coupled with the processor 610 and the CPLD 612, a second MUX 616 communicatively coupled with the processor 610 and the CPLD 612, a first BIOS 618 communicatively coupled with the first MUX 614 (e.g., via a first serial peripheral interface (“SPI”) 620), and a second BIOS 622 communicatively coupled with the second MUX 616 (e.g., via a second SPI 624), the first memory 602, and the second memory 606. The processor 610 is an Ice Lake Xeon D (“ICX-D”) (Intel® Xeon® D processor) in this illustrated implementation but can be another type of processor.

As shown in the implementation of FIG. 6, the second BIOS 622 may include contents stored in a FLASH memory. The contents may include a primary BIOS image 626 and NVRAM 628. As also shown in the implementation of FIG. 6, the first BIOS 618 may include contents stored in a FLASH memory. The contents may include a golden BIOS image 630 and NVRAM 632. The NVRAM 632 of the first BIOS 618 may store a snapshot of the primary BIOS image 626 at a time of backup, which may help ensure version lock and that the golden OS always remains bootable.

In some implementations of the current subject matter, a BIOS recovery procedure can, when automatically triggered, be configured to copy the golden BIOS image 630 from the first BIOS 618 to the primary BIOS image 626 of the second BIOS 622. The active OS may thus be bootable as the “golden” version. Therefore, in the event that OS booting of the active OS cannot occur due to an error, e.g., corrupt second BIOS 622, corrupt primary BIOS image 626, secure boot signature verification failure of the boot loader due to mismatch of UEFI secure boot keys programmed as default in the primary BIOS image 626 (as resulting from, e.g., BIOS upgrade or OS upgrade), or other error, OS booting can still occur by the BIOS recovery procedure being automatically triggered such that a bootable active OS is provided for the second BIOS 622.

In response to the BIOS recovery procedure being automatically triggered, a notification may be automatically generated and transmitted to an operations facility and/or an operations manager responsible for maintaining the computer system to provide notification of the boot failure. The BIOS that failed to boot successfully may thus be assessed and repaired as needed, remotely and/or locally, such as by the operations manager who receives the notification or another maintenance worker who receives the notification directly or is otherwise informed of the need for assessment and/or repair as a result of the notification being transmitted to the operations facility and/or the operations manager. Such assessment and repair may not require any downtime of the computer system since another OS instance may be copied to be the active, bootable BIOS image to maintain functionality of the computer system despite an OS instance being unable to boot successfully.

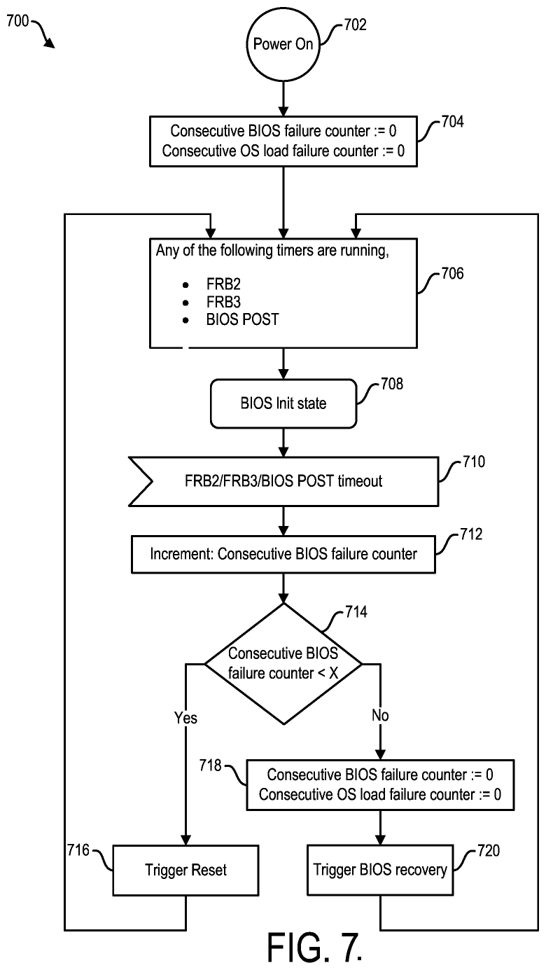

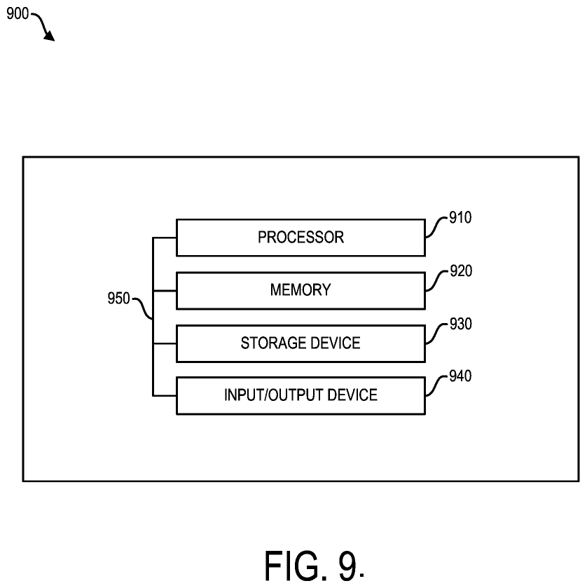

FIG. 7 illustrates one implementation of a method 700 for performing automated BIOS recovery, according to some implementations of the current subject matter. The method 700 may be executed by a BMC, which may be a base station (e.g., one or more base stations 106 of FIGS. 1b-2, base station 301 of FIG. 3, etc.) and/or one or more of its components (e.g., a DU such as the DU 304 of FIG. 3, the DU 508 or 510 of FIGS. 5a-5c, etc.) that may incorporate one or more components of a computer system, such as the computer system 600 of FIG. 6, a computer system 900 of FIG. 9, etc.

In the process 700 of FIG. 7, BIOS recovery is automatically triggered by the BMC on consecutive IPMI BIOS timeouts. In general, the method 700 can track consecutive BIOS initialization failures and trigger a BIOS recovery procedure when a defined failure threshold is breached.

As shown in FIG. 7, the method 700 may include powering on 702 the device, e.g., the BMC. The powering on 702 may automatically trigger timer initialization 704.

The timer initialization 704 may include setting a consecutive BIOS failure counter to zero. The consecutive BIOS failure counter counts a number of BIOS failures that occur consecutively. The consecutive BIOS failure counter can be stored in a memory (e.g., NVRAM 628 of the second BIOS 622 of FIG. 6, memory 920 of FIG. 9, etc.) of the BMC. A processor of the BMC can cause the setting of the consecutive BIOS failure counter to zero.

The timer initialization 704 may also include setting a consecutive OS load failure counter to zero. The OS load failure counter counts a number of failures to load the OS that occur consecutively. The OS load failure counter can be stored in a memory (e.g., NVRAM 628 of the second BIOS 622 of FIG. 6, memory 920 of FIG. 9, etc.) of the BMC. A processor of the BMC can cause the setting of the consecutive OS load counter to zero.

After the timer initialization 704, the method 700 may include running 706 the Watchdog Timer, including use of the BIOS FRB2 timeout Timer Use field and the BIOS POST timeout Timer Use field, and the FRB3 timer. The FRB3 starts counting down whenever the system comes out of hard reset or power-up.

The method 700 may also include a BIO initialization (Init) state 708 in which BIOS initializes and attempts a BIOS POST. If during the BIOS POST attempt a timeout occurs 710 in any of the BIOS FRB2, the BIOS FRB3, or the BIOS POST, the consecutive BIOS failure counter is incremented 712 by one, e.g., the processor causes the stored counter value to increase by one. In other words, in response to occurrence 710 of a BIOS failure, the consecutive BIOS failure counter is incremented 712 by one. Increasing the consecutive BIOS failure counter indicates that a failure was encountered in the BIOS POST process preventing completion of the BIOS POST process.

If BIOS failure does not occur 710, then BIOS POST has occurred successfully, and the process 700 may end.

If BIOS failure occurs 710 and the consecutive BIOS failure counter has been incremented 712 by one, the method 700 may include determining 714, e.g., the processor determining, whether the consecutive BIOS failure counter is less than a BIOS threshold. The threshold may reflect a maximum number of times that the BIOS POST process may be attempted before the active BIOS is deemed to be broken or otherwise non-functional such that BIOS recovery should be performed. The value of the BIOS threshold may be preset and stored at the BIOS, e.g., in NVRAM of the BIOS, or elsewhere accessible to the BIOS. The value of the BIOS threshold may be chosen based on any of a variety of factors, such as a processing power of the processor, a tolerance for downtime in BIOS POST processing, etc. In some implementations, the BIOS threshold may be two, though other values are possible.

In response to determining 714 that the consecutive BIOS failure counter is less than the BIOS threshold, the method 700 may include triggering 714 a reset. The consecutive BIOS failure counter being less than the BIOS threshold indicates that a tolerable number of BIOS POST attempts have not yet occurred so should be reattempted. The method 700 thus returns to running 706 the timers and the BIOS Init state 708 for another BIOS POST attempt, now with the consecutive BIOS failure counter being one greater than during the prior BIOS POST attempt.

In response to determining 714 that the consecutive BIOS failure counter is not less than the BIOS threshold, the method 700 may include setting 718 each of the consecutive BIOS failure counter and the OS load failure counter to zero and triggering 720 a BIOS recovery procedure. The BIOS recovery procedure may therefore be automatically triggered 720 in the event of BIOS failure. The consecutive BIOS failure counter not being less than the BIOS threshold indicates that enough BIOS POST attempts have occurred that it would not be worthwhile to perform another BIOS POST attempt, e.g., since there may be an unrecoverable error that would prevent successful BIOS POST completion regardless of a number of attempts made or since any more BIOS POST attempts would introduce too much time delay that it would be more time efficient to perform a BIOS recovery procedure.

As mentioned above, the BIOS recovery procedure can be implemented in accordance with a typical BIOS recovery procedure, as will be appreciated by those skilled in the art. In general, the BIOS recovery procedure can copy a backup BIOS image (e.g., the golden BIOS image 630 of FIG. 6, etc.) to the active BIOS image (e.g., the primary BIOS image 616 of FIG. 6, etc.) such that the next boot attempt will use the backup BIOS image (now the active BIOS image) to allow for successful a BIOS POST process.

After performance of the BIOS recovery procedure, the method 700 may return to running 706 the timers and the BIO Init state 708 for another BIOS POST attempt, now with the consecutive BIOS failure counter being zero again.

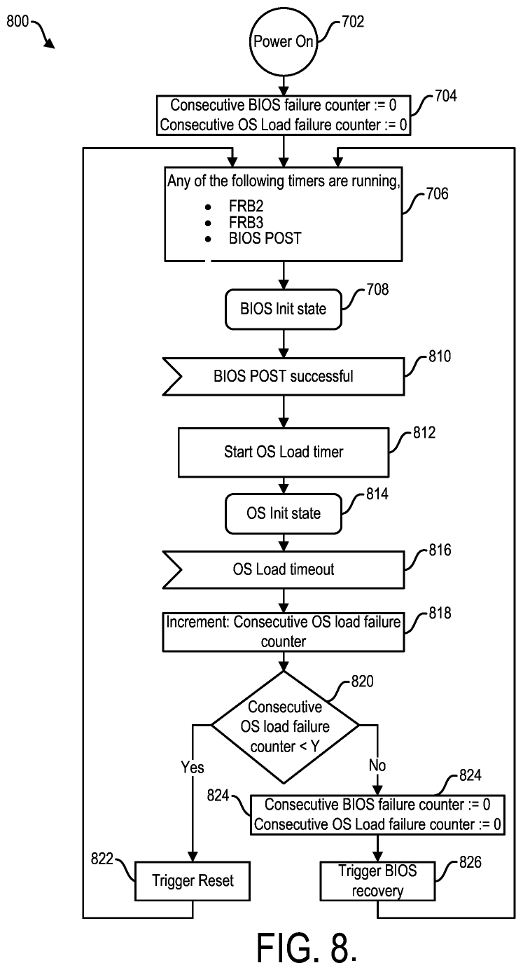

FIG. 8 illustrates another implementation of a method 800 for performing automated BIOS recovery, according to some implementations of the current subject matter. The method 800 may be executed by a BMC, which may be a base station (e.g., one or more base stations 106 of FIGS. 1b-2, base station 301 of FIG. 3, etc.) and/or one or more of its components (e.g., a DU such as the DU 304 of FIG. 3, the DU 508 or 510 of FIGS. 5a-5c, etc.) that may incorporate one or more components of a computer system, such as the computer system 600 of FIG. 6, a computer system 900 of FIG. 9, etc.

In the process 800 of FIG. 8, BIOS recovery is automatically triggered by the BMC on consecutive OS load timeouts. In general, the method 800 can track consecutive OS initialization failures and trigger a BIOS recovery procedure when a defined failure threshold is breached.

As shown in FIG. 8, the method 800 may include powering on 702 the device, e.g., the BMC, as discussed above, which may automatically trigger the timer initialization 704. As discussed above, the timer initialization 704 may include setting each of the consecutive BIOS failure counter and consecutive OS load failure counter to zero. As also discussed above, after the timer initialization 804, the method 800 may include running 706 the Watchdog Timer, including use of the BIOS FRB2 timeout Timer Use field and the BIOS POST timeout Timer Use field, and the FRB3 timer, and the method 800 may also include the BIO Init state 708 in which BIOS initializes and attempts an OS boot.

If BIOS POST is successful 810, e.g., as discussed above with respect to the method 700 of FIG. 7, an OS Load timer starts 812 running. The method 800 of FIG. 8 may thus be performed with some overlap of the method 700 of FIG. 7 with some portion of the method of FIG. 8 occurring after the method 700 has ended with successful BIOS POST. The method 800 of FIG. 8 may also include an OS initialization (Init) state 814 in which OS initializes and attempts to boot.

If during the boot attempt a timeout occurs 816 in the OS Load counter, the consecutive OS load failure counter is incremented 818 by one, e.g., the processor causes the stored counter value to increase by one. In other words, in response to occurrence 816 of an OS load failure in which the OS fails to load, the consecutive OS load failure counter is incremented 818 by one. Increasing the consecutive OS load failure counter indicates that a failure was encountered in the OS boot process preventing completion of the OS boot process.

If OS load failure does not occur 816, then OS booting has occurred successfully, and the process 800 may end.

If OS load failure occurs 816 and the consecutive OS load failure counter has been incremented 818 by one, the method 800 may include determining 820, e.g., the processor determining, whether the consecutive OS load failure counter is less than an OS load threshold. The OS load threshold may reflect a maximum number of times that OS booting may be attempted before the active BIOS is deemed to be unbootable such that BIOS recovery should be performed. The value of the OS load threshold may be preset and stored at the BIOS, e.g., in NVRAM of the BIOS, or elsewhere accessible to the BIOS. The value of the OS load threshold may be chosen based on any of a variety of factors, such as a processing power of the processor, a tolerance for downtime in OS booting, etc. In some implementations, the OS load threshold may be six, though other values are possible.

In response to determining 820 that the consecutive OS load failure counter is less than the threshold, the method 800 may include triggering 822 a reset. The consecutive OS load failure counter being less than the OS load threshold indicates that a tolerable number of OS boot attempts have not yet occurred so should be reattempted. The method 800 thus returns to running 806 the timers and the BIOS Init state 808 for another BIOS POST attempt, now with the consecutive OS load failure counter being one greater than during the prior boot attempt.

In response to determining 820 that the consecutive OS load failure counter is not less than the threshold, the method 800 may include setting 824 each of the consecutive BIOS failure counter and the consecutive OS load failure counter to zero and triggering 826 a BIOS recovery procedure. The BIOS recovery procedure may therefore be automatically triggered 826 in the event of OS loading failure. The consecutive OS load failure counter not being less than the OS load threshold indicates that enough boot attempts have occurred that it would not be worthwhile to perform another boot attempt, e.g., since there may be an unrecoverable error that would prevent booting regardless of a number of attempts made or since any more boot attempts would introduce too much time delay that it would be more time efficient to perform a BIOS recovery procedure.

As mentioned above, the BIOS recovery procedure can be implemented in accordance with a typical BIOS recovery procedure, as will be appreciated by those skilled in the art. In general, the BIOS recovery procedure can copy a backup BIOS image (e.g., the golden BIOS image 630 of FIG. 6, etc.) to the active BIOS image (e.g., the primary BIOS image 616 of FIG. 6, etc.) such that the next boot attempt will use the backup BIOS image (now the active BIOS image) to allow for successful booting.

In some implementations, the current subject matter can be configured to be implemented in a system 900, as shown in FIG. 9. The system 900 can include one or more of a processor 910, a memory 920, a storage device 930, and an input/output device 940. Each of the components 910, 920, 930, 940 can be interconnected using a system bus 950. The processor 910 can be configured to process instructions for execution within the system 600. In some implementations, the processor 910 can be a single-threaded processor. In alternate implementations, the processor 910 can be a multi-threaded processor. The processor 910 can be further configured to process instructions stored in the memory 920 or on the storage device 930, including receiving or sending information through the input/output device 940. The memory 920 can store information within the system 900. In some implementations, the memory 920 can be a computer-readable medium. In alternate implementations, the memory 920 can be a volatile memory unit. In yet some implementations, the memory 920 can be a non-volatile memory unit. The storage device 930 can be capable of providing mass storage for the system 900. In some implementations, the storage device 930 can be a computer-readable medium. In alternate implementations, the storage device 930 can be a floppy disk device, a hard disk device, an optical disk device, a tape device, non-volatile solid state memory, or any other type of storage device. The input/output device 940 can be configured to provide input/output operations for the system 900. In some implementations, the input/output device 940 can include a keyboard and/or pointing device. In alternate implementations, the input/output device 940 can include a display unit for displaying graphical user interfaces.

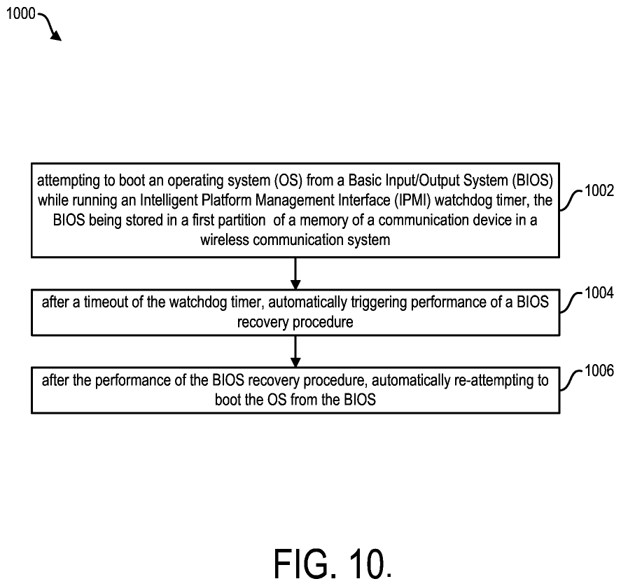

FIG. 10 illustrates an exemplary method 1000 for automated BIOS recovery, according to some implementations of the current subject matter. The method 1000 may be performed, for example, using implementations shown in and described with respect to FIGS. 6-8.

The method 1000 includes attempting to boot an OS from a BIOS (e.g., the second BIOS 622 of FIG. 6, etc.) while running an IPMI watchdog timer. The BIOS is stored in a first partition (e.g., bootable partition 604a or bootable partition 608a of FIG. 6, etc.) of a memory (e.g., the first memory 602 or the second memory 606 of FIG. 6, the memory 920 of FIG. 9, etc.) of a communication device (e.g., a base station (e.g., gNodeB or gNB, eNodeB or eNB, ng-eNodeB or ng-eNB), such as those shown in and discussed above with regard to FIGS. 1a-5c), such as a DU of the base station such as the DU 304 of FIG. 3, the DU 508 or 510 of FIGS. 5a-5c, etc.) in a wireless communication system. The method also includes, after a timeout of the watchdog timer, automatically triggering performance of a BIOS recovery procedure. The method also includes, after the performance of the BIOS recovery procedure, automatically re-attempting to boot the OS from the BIOS.

In some implementations, the current subject matter can include one or more of the following optional features.

In some implementations, the method can further include, after the timeout of the watchdog timer and before triggering the performance of the BIOS recovery procedure, incrementing a failure counter, the method can further include determining if the failure counter is less than a threshold, and the performance of the BIOS recovery procedure can be triggered in response to determining that the failure counter is not less than the threshold. Further, the method can further include, in response to determining that the failure counter is less than the threshold, re-attempting to boot the OS from the BIOS without triggering the performance of the BIOS recovery procedure; the failure counter can be zero when the OS is attempted to be booted from the first BIOS, and the method can further include resetting the failure counter to zero in response to determining that the failure counter is not less than the threshold; and/or the failure counter can be zero when the OS is attempted to be booted from the first BIOS, and the method can further include, in response to the timeout of the watchdog timer, incrementing the failure counter by one.

In some implementations, attempting to boot the OS can includes a BIOS POST attempt, and the timeout of the watchdog timer can occur during the BIOS POST attempt.

In some implementations, attempting to boot the OS can include an attempt to load the OS, and the timeout of the watchdog timer can occur during the OS load attempt.

In some implementations, the timeout of the watchdog timer can include timeout of at least one of a BIOS FRB2 timeout, a BIOS FRB3 timeout, and a BIOS POST timeout.

In some implementations, performing the BIOS recovery procedure can include copying a golden BIOS image stored in a second partition of the memory of the communication device to the BIOS. Further, the golden BIOS image can be pre-stored in the second partition of the memory during manufacturing of the communication device.

In some implementations, the communication device can be a DU.

In some implementations, at least one of the attempting and the automatically attempting can be performed by a base station in the wireless communication system. Further, the base station can include at least one of an eNodeB base station, a gNodeB base station, a wireless base station, and any combination thereof.

In some implementations, the wireless communication system can be at least one of a long term evolution communications system, a new radio communications system, and any combination thereof.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method, comprising:
attempting to boot an operating system (OS) from a Basic Input/Output System (BIOS) while running an Intelligent Platform Management Interface (IPMI) watchdog timer, the BIOS being stored in a first partition of a memory of a communication device in a wireless communication system;
after a timeout of the watchdog timer, automatically triggering performance of a BIOS recovery procedure; and
after the performance of the BIOS recovery procedure, automatically re-attempting to boot the OS from the BIOS.

2. The method of claim 1, further comprising, after the timeout of the watchdog timer and before triggering the performance of the BIOS recovery procedure, incrementing a failure counter; and
determining if the failure counter is less than a threshold;
wherein the performance of the BIOS recovery procedure is triggered in response to determining that the failure counter is not less than the threshold.

3. The method of claim 2, further comprising, in response to determining that the failure counter is less than the threshold, re-attempting to boot the OS from the BIOS without triggering the performance of the BIOS recovery procedure.

4. The method of claim 2, wherein the failure counter is zero when the OS is attempted to be booted from the first BIOS; and
the method further comprises resetting the failure counter to zero in response to determining that the failure counter is not less than the threshold.

5. The method of claim 2, wherein the failure counter is zero when the OS is attempted to be booted from the first BIOS; and
the method further comprises, in response to the timeout of the watchdog timer, incrementing the failure counter by one.

6. The method of claim 1, wherein attempting to boot the OS includes a BIOS Power On Self Test (POST) attempt; and
the timeout of the watchdog timer occurs during the BIOS POST attempt.

7. The method of claim 1, wherein attempting to boot the OS includes an attempt to load the OS; and
the timeout of the watchdog timer occurs during the OS load attempt.

8. The method of claim 1, wherein the timeout of the watchdog timer includes timeout of at least one of a BIOS Fault Resilient Booting level 2 (FRB2) timeout, a BIOS FRB level 3 (FRB3) timeout, and a BIOS Power On Self Test (POST) timeout.

9. The method of claim 1, wherein performing the BIOS recovery procedure includes copying a golden BIOS image stored in a second partition of the memory of the communication device to the BIOS.

10. The method of claim 9, wherein the golden BIOS image was pre-stored in the second partition of the memory during manufacturing of the communication device.

11. The method of claim 1, wherein the communication device is a distributed unit (DU).

12. The method of claim 1, wherein at least one of the attempting and the automatically attempting is performed by a base station in the wireless communication system.

13. The method of claim 12, wherein the base station includes at least one of an eNodeB base station, a gNodeB base station, a wireless base station, and any combination thereof.

14. The method of claim 1, wherein the wireless communication system is at least one of a long term evolution communications system, a new radio communications system, and any combination thereof.

15. An apparatus, comprising:
at least one processor, and
at least one non-transitory storage media storing instructions that, when executed by the at least one processor, cause the at least one processor to perform operations comprising:
attempting to boot an operating system (OS) from a Basic Input/Output System (BIOS) while running an Intelligent Platform Management Interface (IPMI) watchdog timer, the BIOS being stored in a first partition of a memory of a communication device in a wireless communication system,
after a timeout of the watchdog timer, automatically triggering performance of a BIOS recovery procedure, and
after the performance of the BIOS recovery procedure, automatically re attempting to boot the OS from the BIOS.

16-28. (canceled)

29. At least one non-transitory storage media storing instructions that, when executed by at least one processor, cause the at least one processor to perform operations comprising:
attempting to boot an operating system (OS) from a Basic Input/Output System (BIOS) while running an Intelligent Platform Management Interface (IPMI) watchdog timer, the BIOS being stored in a first partition of a memory of a communication device in a wireless communication system;
after a timeout of the watchdog timer, automatically triggering performance of a BIOS recovery procedure; and
after the performance of the BIOS recovery procedure, automatically re attempting to boot the OS from the BIOS.

30-42. (canceled)
